(19) United States
(12) Patent Application Publication
(10) Pub. No.: US 2011/0290376 A1
(43) Pub. Date: Dec. 1, 2011

(54) Pencil Sharpener

(76) Inventor: Anwar M. Farooq, Montclair, CA (US)

(21) Appl. No.: 13/204,694

(22) Filed: Aug. 7, 2011

Related U.S. Application Data
(63) Continuation-in-part of application No. 12/243,668, filed on Oct. 1, 2008, now Pat. No. 8,016,004.

(51) Int. Cl. B43L 23/00

(52) U.S. Cl. 144/28.4; 144/28.3

(57) ABSTRACT

A pencil sharpener comprises a housing comprising an aperture to accept a pencil inserted into an interior. A spring is joined to the interior with the spring configured to loop about the inserted pencil. A plate member comprises an aperture to pass the inserted pencil through the plate member. The plate member is configured for linear movement along a length of the inserted pencil. The spring contracts about the inserted pencil and holds the inserted pencil at a fixed position during movement of the plate toward an end of the inserted pencil. A plurality of cutting blade assemblies is joined to the plate to extend along the inserted pencil. Each of the assemblies comprises a cutting blade configured to shave the inserted pencil. A cone structure is configured to guide the cutting blades to shave the inserted pencil to form a point on the end of the inserted pencil.

### CROSS- REFERENCE TO RELATED APPLICATIONS

The present continuation-in-part patent application claims priority benefit under 35 U.S.C. 120 of the U.S. nonprovisional patent application Ser. No. 12243668 entitled “More Silent and Robust Electric Pencil Sharpener” filed on 1 Oct. 2008, which is hereby incorporated by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to pencil sharpeners. More particularly, the invention relates to a substantially silent pencil sharpener.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Users of pencils typically need to repeatedly sharpen their pencils to maintain a sharp point. Pencils may be used in a wide variety of environments such as, but not limited to, classrooms, testing sites, offices, art studios, homes, etc. In many of these environments, quiet may be desired or even required. By way of educational background, an aspect of the prior art generally useful to be aware of is that various different types of pencil sharpeners are currently available including, without limitation, manual and electric variations.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1 through 4 illustrate the interior components of an exemplary pencil sharpener, in accordance with an embodiment of the present invention. FIG. 1 is a perspective view, FIG. 2 is a side view, FIG. 3 is a perspective end view, and FIG. 4 is an end view;

FIG. 5 illustrates a side view of the internal components of an exemplary pencil sharpener with a rotating cutting mechanism, in accordance with an embodiment of the present invention;

FIGS. 6 and 7 illustrate the internal components of an exemplary pencil sharpener with a collapsible aperture, in accordance with an embodiment of the present invention. FIGS. 6 and 7A are a perspective view, and FIG. 7 is a side view;

FIGS. 8A through 8E illustrate an exemplary pencil sharpener with a multiplicity of blade assemblies, in accordance with an embodiment of the present invention. FIG. 8A is a diagrammatic front view of the sharpener. FIG. 8B is a diagrammatic front view of a cutting disk. FIG. 8C is a diagrammatic top view of the cutting disk. FIG. 8D is a diagrammatic side view of a blade assembly. FIG. 8E is a diagrammatic top view of a blade, and FIG. 3F is a top view of six blades brought together;

FIGS. 10A, 10B and 10C illustrate an exemplary cutting disk using a bent rod from a pencil sharpener with a multiplicity of blade assemblies, in accordance with an embodiment of the present invention. FIG. 10A is a diagrammatic top view. FIG. 10B is a diagrammatic front view of the bent rod in a lowered position, and FIG. 10C is a diagrammatic front view of the bent rod in a raised position;

FIG. 11 is a diagrammatic front view of an exemplary cutting disk using a rack and a pinion in a pencil sharpener comprising multiple blade assemblies, in accordance with an embodiment of the present invention; and

FIG. 12 is a diagrammatic front view of an exemplary manual pencil sharpener comprising multiple blade assemblies, in accordance with an embodiment of the present invention.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Electric pencil sharpeners that are available in the market today do a fairly good job of sharpening pencils; however, they are typically annoyingly noisy. Many competitive exams and schools ban the use of electric pencil sharpeners during testing due to noise. The noise comes from the grinding of the sharpener's metal blade with the pencil's body, which is usually made of wood. The duller the blade the louder and more ineffective the sharpener is. In some cases pencils may need to be reinserted a number of times to make the lead pointed. Sometimes electric pencil sharpeners sharpen pencils such that lead is exposed on only a portion of the pointed end and the remainder of the pointed end is still covered with material from the body of the pencil. When this occurs a user may continue to reinsert the pencil in the hope that next time the lead will be fully exposed. This causes the pencil to become smaller and smaller each time.

A preferred embodiment of the present invention provides a pencil sharpener that should generally eliminate the problems with the prior art previously described. The preferred embodiment is approximately the same size as a regular electric pencil sharpener; however, due to its design the preferred embodiment enables a pencil to be sharpened in less than five seconds with near perfect results every time in just one cycle. The preferred embodiment does not grind the body of the pencil with a rotating metal blade. In fact in the preferred embodiment, neither the pencil nor the blade rotates to sharpen a pencil. Using preferred embodiments, the process of sharpening a pencil is substantially silent other then the slight hum of the motor during operation. Preferred embodiments generally eliminate the half-exposed lead problem described above. The retail price of preferred embodiments should be approximately the same as conventional electric pencil sharpeners. Jamming in a pencil sharpener occurs when the pencil is forced into the sharpener and the motor attached to the cutting assembly fails to handle the extra load and temporarily locks up. In my design, each blade is designed to shave off only a small portion of the material and forcing a pencil will have no effect. To accomplish a jam proof sharpening, a thin flat metal strip loop 106 is installed such that when the motor 131 is energized it rotates gear 101 and the metal strip loop 106 tightens around the pencil 121 and holds it in place thus preventing its movement for the duration of the sharpening process. Once the process of pencil sharpening is completed and the reverse switch 115 reverses the motor 131, the metal strip 106 automatically loosens and releases the pencil 121, thus avoiding jamming the pencil sharpener. The need to hold the pencil is so that the pencil does not move during sharpening. Also that people may not impatiently try to quicken the process by manually rotating the pencil while being sharpened and/or try to pull out the pencil before the cycle is complete, which can damage the blades on the sharpening assembly and or could jam the pencil sharpener.

In a preferred embodiment, a pencil sharpener comprises a central gear with an opening for a pencil. The central gear is surrounded by six smaller gears in a circular fashion, or other suitable numbers of gears, each of which drives a shaft which is angled. The angled shafts converge at the opposite end of the pencil sharpener to aid in guiding the pencil. Each shaft includes a blade mounted on a threaded blade member such that when the central gear rotates, the six blades travel down the shafts, removing material from the pencil to form a hexagonal point. Once the blades reach the ends of the shafts, the operation is reversed and the blades travel away from the point back to their original or resting positions near the central gear.

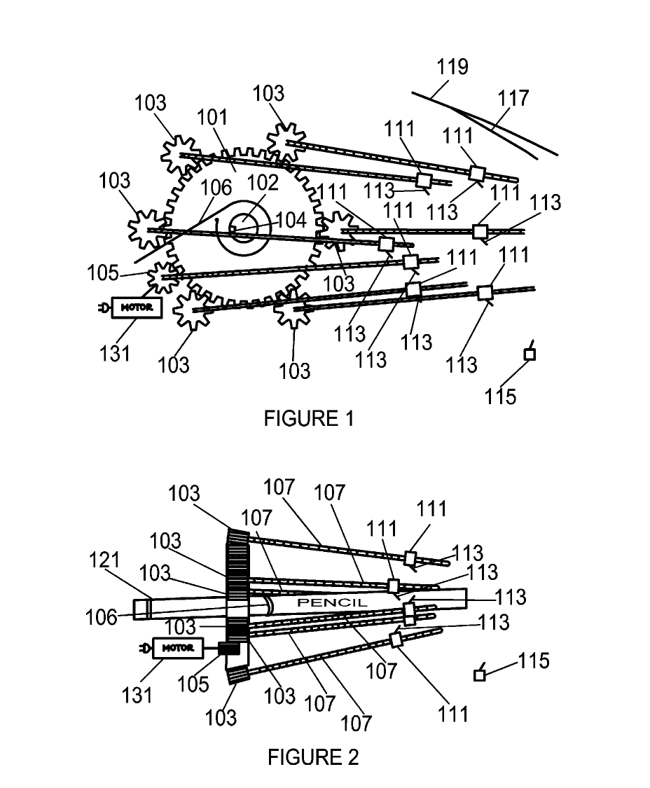

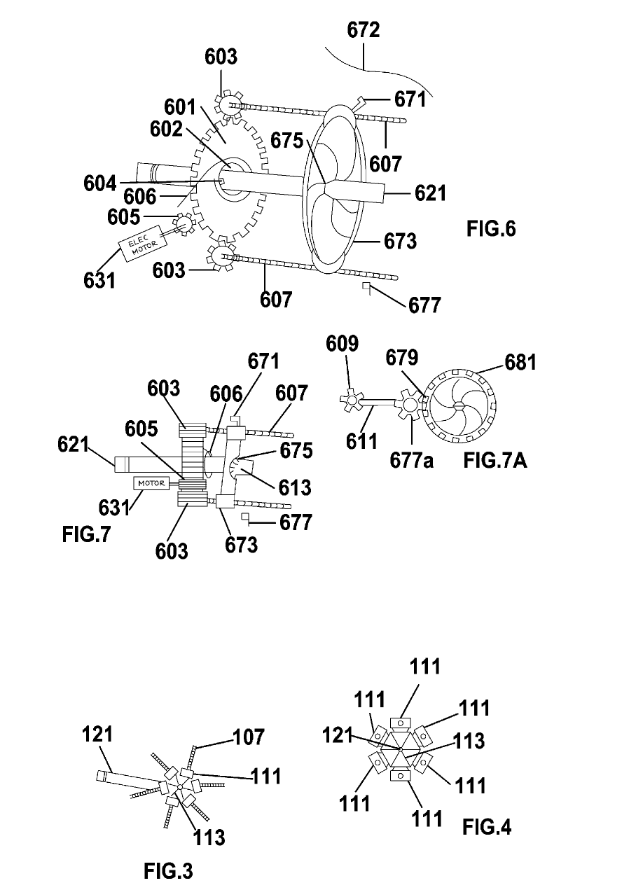

FIGS. 1 through 4 illustrate the interior components of an exemplary pencil sharpener 100, in accordance with an embodiment of the present invention. FIG. 1 is a perspective view, FIG. 2 is a side view, FIG. 3 is a perspective end view, and FIG. 4 is an end view. In the present embodiment, pencil sharpener 100 comprises an electric motor 131 that is energized by switch 104, and is connected to a drive gear 105, which is rotated by motor 131. Drive gear 105 is connected to and rotates a central gear 101. Central gear 101 comprises a central aperture 102 to enable a pencil 121 to be inserted into pencil sharpener 100. Central gear 101 is attached to a housing 119 of pencil sharpener 100 by a round lip around central aperture 102. Around the periphery of central gear 101 are secondary gears 103, which are connected to central gear 101 to rotate with central gear 101. Each secondary gear 103 is connected to an externally threaded shaft 107, which is inwardly inclined towards the center of central gear 101 so that threaded shafts 107 converge at the end of pencil sharpener 100 opposite central gear 101. Threaded shafts 107 comprise external threads to cooperate with the internal threads of blade members 111 each of which has a central aperture with internal threads formed on the interior surface of the central aperture such that when threaded shafts 107 rotate, blade members 111 move the length of threaded shafts 107 without rotation. Each blade member 111 comprises a cutting blade 113 positioned inward to sharpen pencil 121 as it is inserted into pencil sharpener 100. Each blade member 111 is positioned by a rib 117 which is attached to the interior of housing 119 of pencil sharpener 100. Ribs 117 enable blade members 111 to travel along threaded shafts 107 while maintaining cutting blades 113 at inward positions to sharpen the pencil. Pencil sharpener 100 also comprises a limit switch 115 that, when activated by a blade member 111, reverses the direction of the rotation of threaded shafts 107 so that blade members 111 travel back up threaded shafts 107. The present embodiment comprises one limit switch 115 at the end of one threaded shaft 107; however, alternate embodiments may comprise multiple limit switches, for example, without limitation, one limit switch at the end of each threaded shaft.

Referring to FIG. 2, in typical use of the present embodiment, pencil sharpener 100 sharpens pencil 121 mimicking the sharpening of a pencil by a hand using a small pocketknife. The switch 104 energizes the electric motor 131 that rotates gear 105 that in turn rotates the central gear 101 that rotates six secondary gears 103 and the metal strip 106 that locks the pencil 121 tightly in place. Each secondary gear 103 then rotates attached threaded shafts 107. When threaded shafts 107 rotate, blade members 111 with attached sharp blades 113 move the length of threaded shafts 107 without rotation of blade members 111 by being guided by ribs 117 on the inside of housing 119 of pencil sharpener 100. In alternate embodiments, various other means may be used to generally prevent the blade members from rotating, for example, without limitation, slots in the housing in which the blade members slide. In the present embodiment, the shaft and blade assemblies are substantially identical, resulting in six moving blades 113 on six threaded shafts 107. All six threaded shafts 107 converge at the end of pencil sharpener 100 opposite central gear 101; however, threaded shafts 107 do not converge to a point, as blades 113 extend from threaded shafts 107 and converge towards a point. Since many pencils are hexagonal in shape, pencil sharpener 100 comprises six blades 113 in the present embodiment for aesthetic reasons and for each blade to shave off a small amount of material. However, pencil sharpeners in alternate embodiments may comprise more or fewer shafts, blades and secondary gears.

In the present embodiment, the insertion of pencil 121 into pencil sharpener 100 activates a start switch 104 that energizes motor 131. As motor 131 turns, motor 131 turns drive gear 105 to rotate central gear 101. The rotation of central gear 101 rotates the six secondary gears 103 as well as metal strip 106. Since threaded shafts 107 are attached to secondary gears 103, all six threaded shafts 107 rotate simultaneously. Blade members 111 travel on threaded shafts 107 and comprise sharp blades 113 mounted on the external surfaces of blade members 111, and ribs 117 on the interior of housing 119 cooperate with blade members 111 so that blade members 111 travel along threaded shafts and generally prevent blades 113 from rotating, thus maintaining blades 113 in positions opposed to the pencil. The threading on threaded shafts 107 is such that blade members 111 are able to move the length of threaded shafts 107 rapidly. However, in alternate embodiments the threading on the threaded shafts may be designed so that the blade members move more slowly down the shafts. In the present embodiment as pencil 121 is inserted into central aperture 102 of central gear 101, all six blades 113 rapidly move towards pencil 121 from six directions and shave or slice the exterior of pencil 121 along with the internal lead in such a way as to leave the lead finely pointed. At the bottom of threaded shafts 107, blade members 111 trigger limit switch 115 that reverses motor 131 and causes blades 113 of blade members 111 to reverse the direction of travel and to travel up threaded shafts 107 to return to the default starting positions near secondary gears 103 where blade members 111 wait to be reactivated. Some embodiments may comprise one or more limit switches near one or more of the secondary gears to stop the motor once the blade members reach the default positions. In the present embodiment, blades 113 are calibrated and fixed at the correct angle to cause the pencil to sharpen in one cycle. Because pencil 121 does not move and is not grinded, pencil sharpener 100 is virtually noiseless.

Referring to FIG. 3, pencil 121 is shown being sharpened by blade members 111 and cutting blades 113. Blade members 111 are shown traveling along threaded shafts 107. Referring to FIG. 4, an end view of pencil sharpener 100 is shown with pencil 121 in contact with blade members 111 and blades 113.

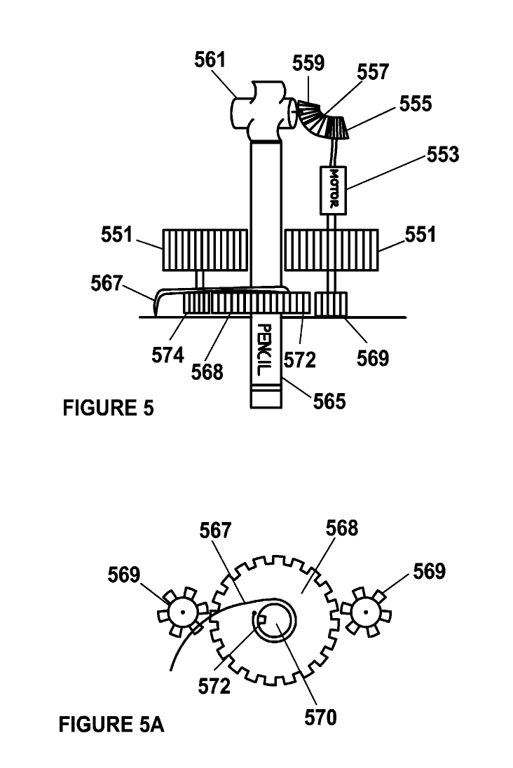

FIG. 5 illustrates a side view of the internal components of an exemplary pencil sharpener 500 with a rotating cutting mechanism 561, in accordance with an embodiment of the present invention. In the present embodiment, pencil sharpener 500 comprises a motor 553 that turns a first drum 551 that is attached to another gear 569. The gear 569 rotates a central gear 568 which in turn rotates another gear 574. Gear 574 is connected to a second drum 551. A metal strip loop 567 is used to firmly hold the pencil in place while being sharpened. When a pencil is inserted through the central gear opening 570, it also passes through the metal strip loop 567 and at the same time activates switch 572 that energizes the motor. As the motor 553 is energized, it tightens the metal strip loop 567 around the pencil 565 thus preventing its movement and causes the blade assembly 561 to rotate as well. This step shave the material off the pencil 565 while simultaneously drums 551 rotate the pencil 565 thus providing the unshaved surface of the pencil 565 for shaving by the blade assembly 561. In addition, motor 553 turns a first gear 555, which in turn rotates a second gear 557, which in turn rotates a third gear 559, which rotates cutting mechanism 561 to sharpen the pencil 565 as pencil 565 is being turned by rotating drums 551.

In the present embodiment of the present invention, rotating cutting mechanism 561 comprises two or more blades. However, alternate embodiments may be configured so that the cutting mechanism has only one blade. In the present embodiment, pencil 565 rotates as well as cutting mechanism 561. In typical use of the present embodiment, when pencil 565 is inserted into opening 570 of the pencil sharpener 500, it goes through metal strip loop 567 and activates the start switch, 572 that energizes motor 553 and causes cutting mechanism 561 to rotate by the rotation transferred to cutting mechanism 561 through gears 555, 557 and 559. Alternate embodiments may comprise alternate means for causing the cutting mechanism to rotate such as, but not limited to, a drive belt connecting the motor to the cutting mechanism, or directly drive the cutting mechanism with another small motor. The blades on cutting mechanism 561 shave material from pencil 565. Then pencil 565 is rotated by rotating drums 551 to expose the next unshaved surface of pencil 565 to cutting mechanism 561. At this time, another blade on cutting mechanism 561 rotates around to pencil 565 and slices the next portion of exposed material from pencil 565. Since pencil 565 and the blades of cutting mechanism 561 rotate in sync and at a fast rate, within seconds all surfaces of pencil 565 are shaved in such a way that pencil 565 is left with a pointed lead. In alternate embodiments, the pencil sharpener may comprise multiple rotating cutting mechanisms, for example, without limitation, two rotating cutting mechanisms on opposite sides of the pencil, so that the pencil may be sharpened in less time. These embodiments may require more gears or other rotation means in order to rotate the additional cutting mechanisms.

FIGS. 6, 7 and 7A illustrate the internal components of an exemplary pencil sharpener 600 with a collapsible aperture 675, in accordance with an embodiment of the present invention. FIG. 6 is a perspective view, and FIG. 7 is a side view. In the present embodiment, pencil sharpener 600 comprises a central gear 601 comprising a central aperture 602 to cooperate with a pencil 621 to be sharpened. Central gear 601 is rotated by a drive gear 605, which is connected to a motor 631. Central gear 601 is connected to a first secondary gear 603 and a second secondary gear 603, and central gear 601 rotates secondary gears 603. Alternate embodiments may comprise more or fewer secondary gears. In the present embodiment, secondary gears 603 rotate externally threaded shafts 607, which comprise external threads to cooperate with internal threads of a round assembly 673. Round assembly 673 comprises a collapsible aperture 675 that has cutting blades 613 around the periphery of collapsible aperture 675. Round assembly 673 comprises a lever 671 that, when depressed, reduces the diameter of collapsible aperture 675 causing cutting blades 613 to progressively shave off material on the pencil, resulting in the sharpening of the pencil 621. Lever 671 is increasingly depressed by a ridge on a housing 672) of pencil sharpener 600 as round assembly 673 travels away from central gear 601 and secondary gears 603 since the interior of housing 672 or a portion of the interior of housing 672 tapers toward the end of pencil sharpener 600 away from central gear 601.

In typical use of the present embodiment, collapsible aperture 675 in round assembly 673 contracts when lever 671 on one side of round assembly 673 is depressed, and when the pressure is released from lever 671, a spring inside round assembly 673 causes collapsible aperture 675 to return to a default fully open position. Round assembly 673 moves back and forth on threaded shafts 607. In the present embodiment, collapsible aperture 675 comprises six blades 613 arranged around collapsible aperture 675 at an angle to increase the penetration of the material of pencil 621 by blades 613. However, alternate embodiments may comprise more or fewer blades on the collapsible aperture. When inserted into pencil sharpener 600 in the present embodiment, pencil 621 passes through opening 602 while activating the switch 604 and passing through metal strip loop 606 and through collapsible aperture 675. The start switch 604 energizes motor 631 that rotates drive gear 605 that in turn rotates central gear 601. Central gear 601 then rotates threaded shafts 607 through secondary gears 603, the rotation of which causes round assembly 673 to travel the length of threaded shafts 607. At the same time, the ridge on the inside of housing 672, which is angled toward the end of pencil sharpener 600 away from central gear 601, causes lever 671 to depress inwards. In an alternate embodiment, the housing of the pencil sharpener may not comprise a ridge, and instead the lever is depressed by the housing itself. In this embodiment the entire housing may be angled toward the end of the pencil sharpener. In the present embodiment, the depression of lever 671 by the ridge on housing 672 causes collapsible aperture 675 to constrict or close. At this time, the six blades 613 arranged around collapsible opening 675 in a circular fashion, penetrate the body of pencil 621 and start shaving material from pencil 621. This continues until lever 671 is depressed fully, which causes collapsible aperture 675 to become sufficiently small for blades 613 to leave the lead of pencil 621 in a fine pointed state. At the end of the cycle, lever 671 is released from the pressure of the ridge, which causes collapsible aperture 675 to fully open, and a limit switch 677, reverses motor 631 and round assembly 673 travels back to the original default position near central gear 601, ready to repeat the cycle. Some embodiments may comprise a second switch near the central gear to stop the motor once the round assembly reaches the starting position. In an alternate embodiment, the pressure of the ridge is not released from the lever once the round assembly reaches the end of the cycle. Instead, in this embodiment, the round assembly triggers a limit switch at the end of the cycle, which causes the motor to reverse to return the round assembly to the default position. As the round assembly travels back to the default position, the pressure on the lever is gradually released as the lever travels backward along the angled ridge, gradually opening the collapsible opening to the default open position.

Another embodiment as shown in FIG. 7A where there is an additional gear 609 that along with the two secondary gears 603 are all rotated by central gear 601. The third gear 609 has a stem 611 and at the end of the stem 611 there is another gear 677 that meshes with the gears 679 on an alternate round assembly 681. Gear 679 takes the place of lever 671 and the rotation of gear 679 causes the aperture opening to close and when the motor 631 reverses, gear 677 reverses, that causes gear 679 to rotate in reverse also. This causes the aperture 675 to open.

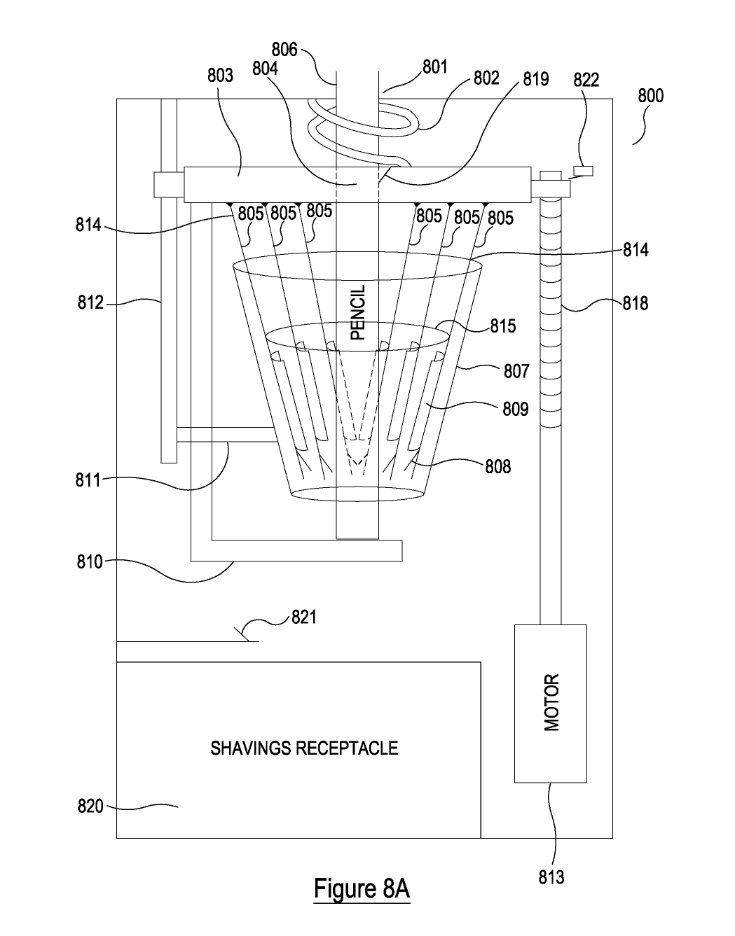

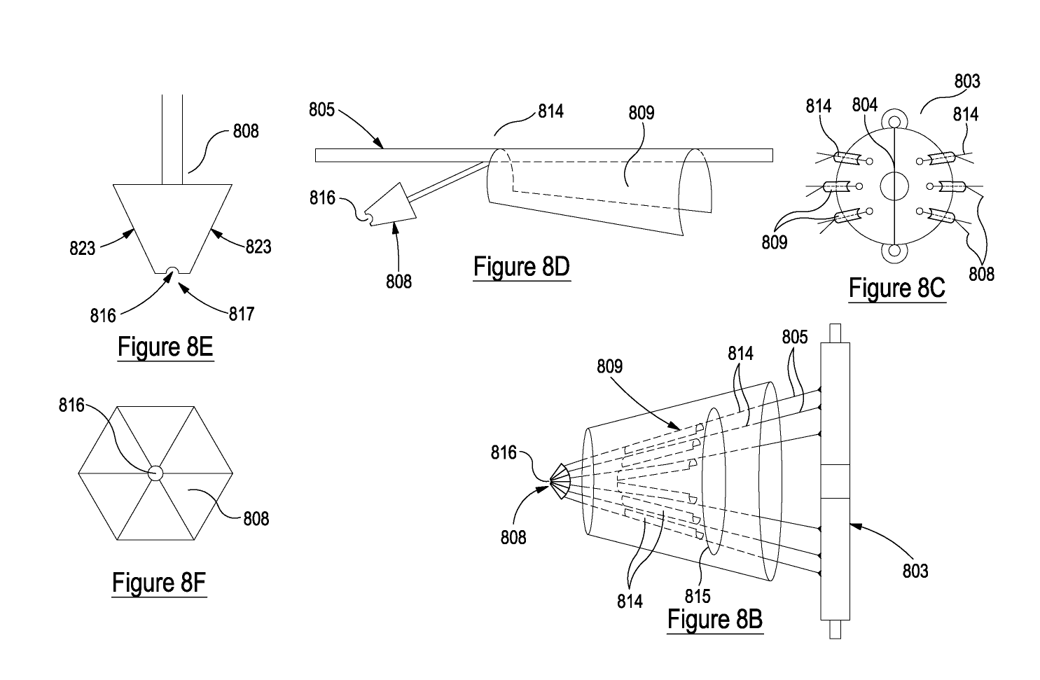

FIGS. 8A through 8E illustrate an exemplary pencil sharpener 800 with a multiplicity of blade assemblies 814, in accordance with an embodiment of the present invention. FIG. 8A is a diagrammatic front view of sharpener 800. FIG. 8B is a diagrammatic front view of a cutting disk 803. FIG. 8C is a diagrammatic top view of cutting disk 803. FIG. 8D is a diagrammatic side view of a blade assembly 814. FIG. 8E is a diagrammatic top view of a blade 808, and FIG. 8F is a top view of six blades brought together. In the present embodiment, pencil sharpener 800 comprises six blade assemblies 814. The six blade assemblies 814 are attached in a circular fashion on disk 803. Disk 803 is a circular disk; however, in alternate embodiments this element may be implemented as a plate of various different shapes such as, but not limited to, ovals, squares, rectangles, hexagons, etc. Referring to FIG. 8D, in the present embodiment, each blade assembly 814 comprises a pin 805 that has a blade 808 attached at an angle. Referring to FIG. 8E, each blade 808 comprises a leading edge 817 and two side edges 823 for a total of three sharpened edges in the shape of a trapezoid. Leading edge 817 of each blade 808 has a small notch 816, which is ⅙^{th} of a small circle. Referring to FIG. 8F, when all six blade assemblies 814 are brought together, a small circular hole is formed by notches 816 in the middle of the six blades 808. The six blades 808 form a conical shape when they are brought together. The six blades 808 are calibrated and fixed at the correct angel to cause a pencil 806 to be sharpened in one cycle.

Referring to FIGS. 8A through 8D, each blade assembly also includes, without limitation, a cone flap 809 that is affixed to the pin 805. Each cone flap 809 is a ⅙^{th} piece of a cone. Referring to FIG. 8A, the six blade assemblies 814 reside inside a fixed cone 807 that is affixed to the body of pencil sharpener 800 by a fixed arm 811, which is attached to a fixed support pin 812. Fixed cone 807 is open on both ends. The six blade assemblies 814 together move back and forth inside fixed cone 807 with cone flaps 809 keeping each blade assembly 814 in proper alignment. Together all six cone flaps 809 make a conical shape. Each blade assembly 814 is attached to a wire spring 815. Assuming that the pin 805 is made of metal, the wire spring 815 could be soldered or welded to the pin 805. If made out of plastic, the 815 could be attached using adhesive or molded as one piece. A switch 819 at and the opening 801 of pencil sharpener 800 energizes electric motor 813. A flat spring 802 is attached such that one end of flat spring 802 is tied to the body of pencil sharpener 800 and the other end is tied to disk 803. Disk 803 rides on a threaded screw 818 that is attached directly to or through a gear reduction to a motor 813. A portion of disk 803 comprises complementary threads to threaded screw 818 which results in the linear movement of disk 803 in an up or down direction depending on the rotation of the shaft of motor 813.

In typical use of the present embodiment, pencil sharpener 800 sharpens pencil 806 by mimicking the sharpening of a pencil by hand using a small knife. In this electric version, the six blades 808 simultaneously move in and shave off the body material of pencil 806 from six sides in a hexagonal fashion while at the same time, shaving the lead of pencil 806 to a fine point. When pencil 806 is inserted through opening 801, pencil 806 presses start switch 819 and passes through flat spring 802, through a central hole 804 in disk 803, through fixed cone 807, and through the middle of the six blade assemblies 814 to a pencil stop 810 where pencil 806 comes to a rest. The pressing of start switch 819 by pencil 806 energizes electric motor 813, and motor 813 starts to rotate. The rotation causes threaded screw 818 to rotate and disk 803 to move linearly. The movement of disk 803 causes flat spring 802 to tighten around pencil 806 in order to keep pencil 806 in a locked position for the duration of use. The movement of disk 803 also causes the six blade assemblies 814 to be pushed deeper into the smaller end of fixed cone 807. The movement of the six blade assemblies 814 inside fixed cone 807 also compresses a wire spring 815 around all six of the blade assemblies 814. Since pencil 806 is situated in the middle of the six blade assemblies 814, the movement of disk 803 causes the six blades 808 to penetrate the skin of pencil 806. The continuous movement of disk 803 forces the six blades 808 to move closer together and out of the small end of fixed cone 807 while shaving the body material off of pencil 806. The shavings from pencil 806 fall into a shavings receptacle 820. The six blades assemblies 814 continue to move in ever tightening formation, ultimately taking a conical shape. The pencil lead passes through the circular hole created by notches 816 whose ridges are sharp. As the six blade assemblies 814 continue to travel over the pencil lead, the circular hole sharpens the lead to a fine point.

After sharpening the lead of pencil 806, the six blade assemblies 814 move past the lead. At this point, pencil stop 810 reaches a reverse switch 821, causing motor 813 to reverse the direction of rotation. As disk 803 is riding threaded screw 818, the reversing of motor 813 causes disk 803 to travel back to the original starting position. As disk 803 moves back, it pulls the six blade assemblies 814 back to the starting position also. The six blade assemblies 814 move away from each other due to them being in the more open space of the wider part of fixed cone 807 and due to the uncompressing energy of wire spring 815 that is attached to each blade assembly 814. The six blade assemblies 814 spread farther apart inside fixed cone 807 causing blades 808 to move away from pencil 806. The backward movement of disk 803 loosens the grip of flat spring 802 around pencil 806, thus enabling pencil 806 to be removed from pencil sharpener 800. As disk 803 and blade assemblies 814 are moved further back, disk 803 reaches a cut-off switch 822 that shuts off motor 813. The sharpened pencil 806 may now be manually pulled out of pencil sharpener 800.

Those skilled in the art, in light of the teachings of the present invention, will readily recognize that various different numbers of blades (and shapes) may be used in some alternate embodiments. FIG. 9 shows by way of example how the six blades 808 will come together and the hole 916 is the same as hole 816.

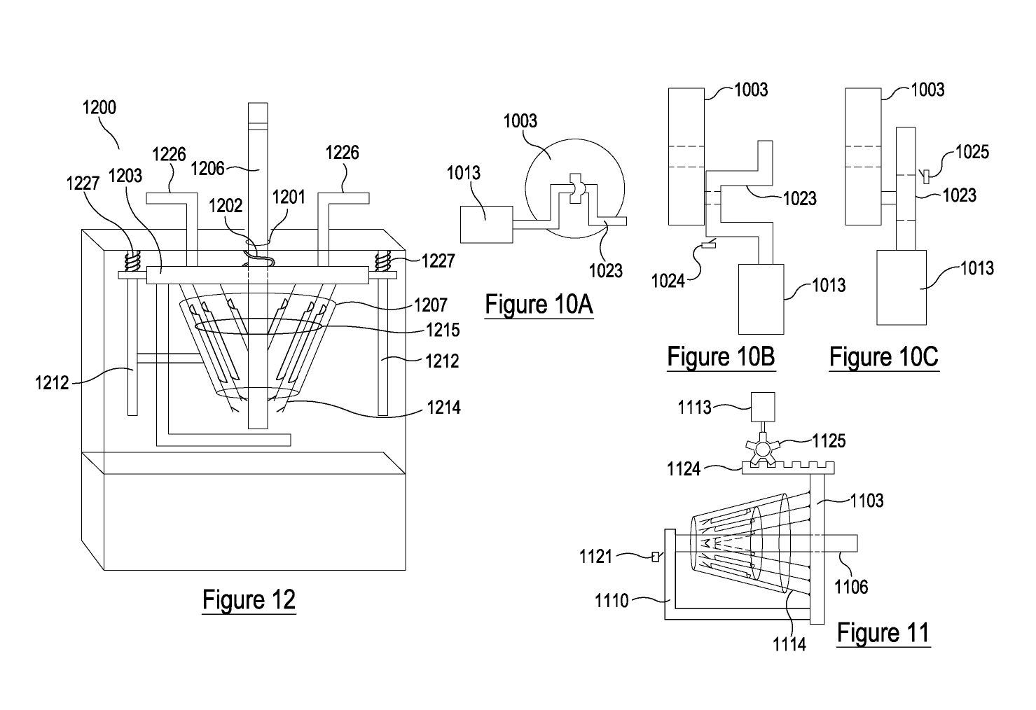

FIGS. 10A, 10B and 10C illustrate an exemplary cutting disk 1003 using a bent rod 1023 from a pencil sharpener with a multiplicity of blade assemblies, in accordance with an embodiment of the present invention. FIG. 10A is a diagrammatic top view. FIG. 10B is a diagrammatic front view of bent rod 1023 in a lowered position, and FIG. 10C is a diagrammatic front view of bent rod 1023 in a raised position. In the present embodiment, bent rod 1023 is attached to a motor 1013. Bent rod 1023 in turn is attached to disk 1003. When energized, motor 1013, which may be a DC motor or a stepper motor, rotates a ¼ turn in the counter clockwise direction, thus pushing disk 1003 in the desired direction to the lowered position, resulting in the shaving of a pencil inserted into the pencil sharpener. This process results in sharpening the pencil. Referring to FIG. 10B, bent rod 1023, at the end of the ¼ turn, hits a switch 1024 that immediately reverses the rotation of motor 1013. Then, bent rod 1023 is rotated ¼ turn in the clockwise direction pulling disk 1003 back to the raised position and releasing the sharpened pencil. Referring to FIG. 10C, as bent rod 1023 completes the ¼ turn in the clockwise direction, bent rod 1023 hits a switch 1025 that turns motor 1013 off. In FIG. 10c The shaft is labeled as 1023, the motor is labeled as 1013. In FIG. 8B the notch is labeled as 816.

FIG. 11 is a diagrammatic front view of an exemplary cutting disk 1103 using a rack 1124 and a pinion 1125 in a pencil sharpener comprising multiple blade assemblies 1114, in accordance with an embodiment of the present invention. In the present embodiment, a motor 1113 is fixed and the motor shaft ends in pinion 1125. Pinion 1125 travels on a moveable flat bar or rack 1124 that has corresponding teeth to match pinion 1125. Rack 1124 is affixed to disk 1103. The movement of pinion 1125 causes rack 1124 to move linearly. Disk 1103 is connected to rack 1124 and therefore the movement of rack 1124 causes disk 1103 to move linearly also. This linear movement of disk 1103 moves blade assemblies 1114 resulting in the sharpening of a pencil 1106. As pencil 1106 is sharpened, a pencil stop 1110 hits a switch 1121 that causes motor 1113 to reverse direction.

FIG. 12 is a diagrammatic front view of an exemplary manual pencil sharpener 1200 comprising multiple blade assemblies 1214, in accordance with an embodiment of the present invention. In the present embodiment, pencil sharpener comprises handles 1226 to manually move blade assemblies 1214 without a motor. Handles 1226 are directly attached to a disk 1203. After a pencil 1206 is inserted in an opening 1201, handles 1226 are pushed down. The pushing down on handles 1226 results in the following operations. Springs 1227 are stretched. A flat spring 1202 is stretched. Disk 1203 is pushed down along fixed support pins 1212, and a wire spring 1215 is constricted around blade assemblies 1214. Disk 1203 along with the six blade assemblies 1214 are pushed down into a fixed cone 1207. This results in shaving material off of pencil 1206. Handles 1226 are pulled back up to the original position by the contraction of springs 1227, and pencil 1206 is loosened by the loosening of flat spring 1202. Some alternate embodiments may be implemented with a single handle or more than two handles.

Those skilled in the art, in light of the present teachings, will readily recognize that there is a multiplicity of alternative and suitable designs for the exterior housings of pencil sharpeners according to embodiments of the present invention. For example, without limitation some embodiments may be deigned to be hand held while other embodiments may be designed to sit on a desk or be mounted to a wall. Furthermore, various different features may be included in the exterior housing such as, but not limited to, removable compartments for emptying pencil shavings, multiple holes for pencils of different sizes, a transparent exterior or window to see when the pencil sharpener is full of shavings, etc. Also electric embodiments of the present invention may be battery powered or may plug into a wall outlet.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a pencil sharpener that is quiet and effective according to the present invention will be apparent to those skilled in the art. The invention has been described above by way of illustration, and the specific embodiments disclosed are not intended to limit the invention to the particular forms disclosed. For example, the particular implementation of the drive system may vary depending upon the particular type of power source used. The power sources described in the foregoing were directed to electric implementations; however, similar techniques are to provide drive systems that may be powered without electricity, for example, without limitation, by a hand crank. Non-electric implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A pencil sharpener comprising:
a housing comprising an aperture being configured to accept a pencil inserted into an interior of said housing;
a spring comprising a first end and a second end, said first end being joined to said interior with said spring being configured to loop about the inserted pencil;
a first plate member disposed within said housing, said first plate member comprising a plate aperture being configured to pass the inserted pencil through the first plate member, said first plate member being configured for linear movement along a length of the inserted pencil, said second end of said spring being joined to said first plate member to enable said spring to contract about the inserted pencil and hold the inserted pencil at a fixed position relative to said housing during movement of said first plate in a direction toward an end of the inserted pencil;
a plurality of cutting blade assemblies being joined to said first plate to extend along the inserted pencil and toward the end of the inserted pencil, each of said assemblies comprising a cutting blade being configured to shave the inserted pencil; and
a cone structure being fixedly joined to said housing, said cone structure being configured to surround said plurality of cutting blade assemblies, said cone structure being operable to guide said cutting blades to shave the inserted pencil to form a point on the end of the inserted pencil with a movement of said first plate toward the end of the inserted pencil.

2. The pencil sharpener as recited in claim 1, further comprising a pencil stop plate joined to said first plate, said pencil stop plate being configured to engage the end of the inserted pencil to stop the insertion of the inserted pencil at a determined position.

3. The pencil sharpener as recited in claim 1, in which each of said plurality of cutting blade assemblies further comprises a pin structure joined to said first plate, and a cone flap joined to said pin structure and configured for engagement of an interior of said cone structure, said cutting blade being joined to said pin structure distally from said first plate and said cone flap.

4. The pencil sharpener as recited in claim 3, in which each of said cutting blades comprises a trapezoidal shape with a notch on a distal side.

5. The pencil sharpener as recited in claim 4, in which said plurality of cutting blade assemblies are configured to form a conical shape with said notches forming an aperture.

6. The pencil sharpener as recited in claim 1, further comprising a wire spring being joined to said plurality of cutting blade assemblies and being configured to urge said cutting blades away from the inserted pencil with movement of said first plate away from the end of the inserted pencil.

7. The pencil sharpener as recited in claim 1, further comprising means being configured for manually moving said first plate to sharpen the inserted pencil.

8. The pencil sharpener as recited in claim 1, further comprising a motor assembly being configured for moving said first plate to sharpen the inserted pencil.

9. The pencil sharpener as recited in claim 8, in which said motor assembly comprises a motor and a threaded shaft in engagement with said motor and said first plate.

10. The pencil sharpener as recited in claim 8, in which said motor assembly comprises a motor and a rack and pinion assembly in engagement with said motor and said first plate.

11. The pencil sharpener as recited in claim 8, in which said motor assembly comprises a motor and a cam assembly in engagement with said motor and said first plate.

12. The pencil sharpener as recited in claim 8, further comprising a plurality of switches within said housing being configured for operating said motor assembly to sharpen the inserted pencil upon insertion of the inserted pencil.

13. The pencil sharpener as recited in claim 1, further comprising a shavings receptacle being configured for retaining pencil shavings.

14. A pencil sharpener comprising:
a housing comprising an aperture being configured to accept a pencil inserted into an interior of said housing;
means being joined to said interior and being configured for looping about the inserted pencil to hold the inserted pencil at a fixed position relative to said housing;
means being configured for linearly moving along a length of the inserted pencil, said looping means being joined to said moving means to hold the inserted pencil during movement of said moving means in a direction toward an end of the inserted pencil;
means being configured for engaging the end of the inserted pencil to stop the insertion of the inserted pencil at a determined position;
means being joined to said moving means and being configured for shaving the inserted pencil;
means being configured for guiding said shaving means to shave the inserted pencil to form a point on the end of the inserted pencil with a movement of said moving means toward the end of the inserted pencil; and
means being configured for urging said shaving means away from the inserted pencil with movement of said moving means away from the end of the inserted pencil.

15. The pencil sharpener as recited in claim 14, further comprising means being configured for manually moving said moving means to sharpen the inserted pencil.

16. The pencil sharpener as recited in claim 14, further comprising means being configured for automatically operating said moving means to sharpen the inserted pencil upon insertion of the inserted pencil.

17. A pencil sharpener comprising:
a housing comprising an aperture being configured to accept a pencil inserted into an interior of said housing;
a spring comprising a first end and a second end, said first end being joined to said interior with said spring being configured to loop about the inserted pencil;
a first plate member disposed within said housing, said first plate member comprising a plate aperture being configured to pass the inserted pencil through the first plate member, said first plate member being configured for linear movement along a length of the inserted pencil, said second end of said spring being joined to said first plate member to enable said spring to contract about the inserted pencil and hold the inserted pencil at a fixed position relative to said housing during movement of said first plate in a direction toward an end of the inserted pencil;
a pencil stop plate joined to said first plate, said pencil stop plate being configured to engage the end of the inserted pencil to stop the insertion of the inserted pencil at a determined position;
a plurality of cutting blade assemblies being joined to said first plate to extend along the inserted pencil and toward the end of the inserted pencil, each of said assemblies comprising a pin structure being joined to said first plate, and a cone flap being joined to said pin structure and a cutting blade being joined to said pin structure distally from said first plate and said cone flap, said cutting blade comprising a trapezoidal shape with a notch on a distal side, said cutting blade being configured to shave the inserted pencil in which said plurality of cutting blade assemblies are configured to form a conical shape with said notches forming an aperture;
a cone structure being fixedly joined to said housing, said cone structure being configured to surround said plurality of cutting blade assemblies, said cone structure being operable to guide said cutting blades to shave the inserted pencil to form a point on the end of the inserted pencil with a movement of said first plate toward the end of the inserted pencil; and
a wire spring joined to said plurality of cutting blade assemblies and being configured to urge said cutting blades away from the inserted pencil with movement of said first plate away from the end of the inserted pencil.

18. The pencil sharpener as recited in claim 17, further comprising means being configured for manually moving said moving means to sharpen the inserted pencil.

19. The pencil sharpener as recited in claim 17, further comprising means being configured for automatically operating said moving means to sharpen the inserted pencil upon insertion of the inserted pencil.

20. The pencil sharpener as recited in claim 17, further comprising a shavings receptacle being configured for retaining pencil shavings.
